(19) United States
(12) Patent Application Publication
(10) Pub. No.: US 2016/0219136 A1
(43) Pub. Date: Jul. 28, 2016

(54) ELECTRONIC DEVICE AND CONTROL METHOD

(71) Applicant: KYOCERA CORPORATION, Kyoto-shi, Kyoto (JP)

(72) Inventors: Akiko WATANABE, Hachioji-shi, Tokyo (JP); Mitsutaka HATA, Yokohama-shi, Kanagawa (JP); Osamu HASHIMOTO, Yamato-shi, Kanagawa (JP); Ryo KIHARA, Yokohama-shi, Kanagawa (JP); Tomohiro SUDOU, Yokohama-shi, Kanagawa (JP)

(21) Appl. No.: 15/025,545

(22) PCT Filed: Sep. 5, 2014
(86) PCT No.: PCT/JP2014/073580

§ 371 Date: Mar. 28, 2016

(30) Foreign Application Priority Data
Sep. 30, 2013 (JP) 2013-205489

(51) Int. Cl. H04M 1/57; H04M 1/2745; H04M 1/60

(52) U.S. Cl. CPC H04M 1/57; H04M 1/6066; H04M 1/274533

(57) ABSTRACT

An electronic device (e.g., mobile phone) includes a communication module (e.g., second communication module) for communicating with other electronic device, and a controller-for performing, when caller information related to a caller of a communication received by the other electronic device is notified, control for the caller information by referring to information in a phone book. Furthermore, it may be configured that, when an incoming call along with the caller information including a phone number of an incoming voice call received by the other electronic device is notified, the controller performs the control for the phone number by referring to the information in the phone book.

### FIELD

The present application relates to an electronic device and a control method.

### BACKGROUND

A technology for performing, when there is an incoming call to a mobile phone, a telephone communication related to the incoming call using other electronic device is known. A separation type mobile phone of a wireless headset type provided with a wireless module responding to, for example, Bluetooth (registered trademark) is proposed. The technology allows a user to make or receive a phone call while a headset is worn on his/her ear while a phone body is placed in a bag (see Patent Literature 1).

### CITATION LIST

### Patent Literature

Patent Literature 1: Japanese Laid-open Patent Publication No. 2003-134224

### SUMMARY

### Technical Problem

The electronic device such as the headset transmits only information about a phone number as information related to an incoming call. Therefore, there is room in the technology for improvement of user's convenience with respect to the control of information related to an incoming call. For the foregoing reasons, there is a need for an electronic device and a control method capable of improving the user's convenience with respect to the control of information related to an incoming call.

### Solution to Problem

In one aspect according to the present invention, there is provided an electronic device comprising: a communication module for communicating with other electronic device; and a controller for performing, when originator information related to an originator of a communication received by the other electronic device is notified, control for the originator information by referring to information in a phone book.

In another aspect according to the present invention, there is provided an control method for an electronic device including a communication module, the control method comprising: a step of communicating with other electronic device in the communication module; and a step of performing, when originator information related to an originator of a communication received by the other electronic device is notified, control for the originator information by referring to information in a phone book.

### BRIEF DESCRIPTION OF DRAWINGS

FIG. 1 is a diagram illustrating an example of notification of an incoming call.

FIG. 2 is a diagram illustrating an example of information of the incoming call.

FIG. 3 is a block diagram of a mobile phone for relaying voice data of a communication.

FIG. 4 is a block diagram of a mobile phone to which voice data of the communication is relayed.

FIG. 5 is a diagram illustrating an example of phone book data.

FIG. 6 is a diagram illustrating an example of phone book data.

FIG. 7 is a sequence diagram illustrating operations upon the arrival of a communication.

FIG. 8 is a sequence diagram illustrating a modification of the operations upon the arrival of the communication.

FIG. 9 is a sequence diagram illustrating another modification of the operations upon the arrival of the communication.

FIG. 10 is a sequence diagram illustrating another modification of the operations upon the arrival of the communication.

### DESCRIPTION OF EMBODIMENTS

Exemplary embodiments for implementing the electronic device and the control method according to the present application will be explained in detail below with reference to the accompanying drawings.

### Embodiment

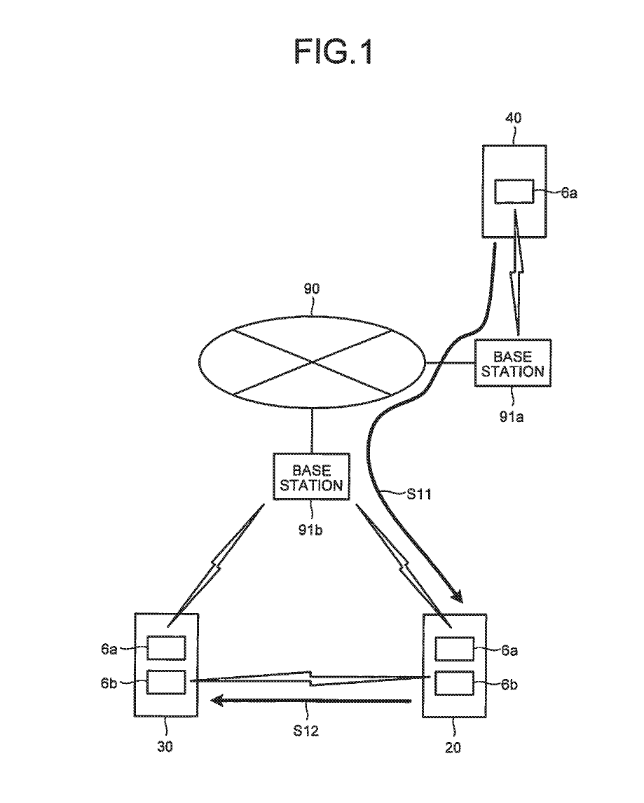

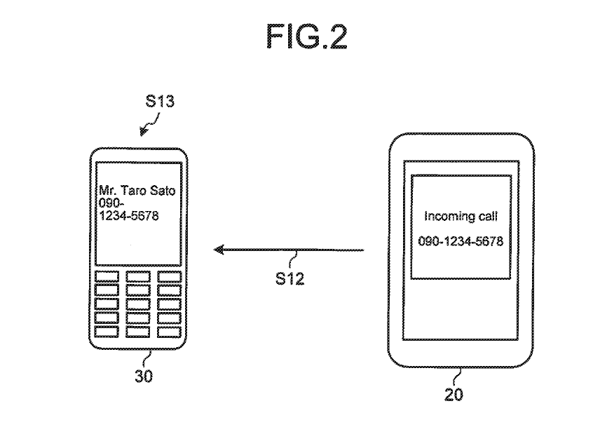

A communication control method according to an embodiment will be explained with reference to FIG. 1 and FIG. 2. FIG. 1 is a diagram illustrating an example of notification of an incoming call. FIG. 2 is a diagram illustrating an example of information of the incoming call. Mobile phones 20, 30, and 40 illustrated in FIG. 1 respectively include communication modules 6a. The mobile phones 20 and 30 further include communication modules 6b respectively.

The communication module 6a is configured so as to be able to make a call through a public line network 90. In the situation illustrated in FIG. 1, the communication modules 6a of the mobile phones 20 and 30 are connected to the public line (carrier line) network 90 via wireless communication with a base station 91b. In the situation illustrated in FIG. 1, the communication module 6a of the mobile phone 40 is connected to the public line network 90 via wireless communication with a base station 91a.

The communication module 6b is configured so as to be able to forward call voice data received by the communication module 6a. The communication module 6b is directly connected to other electronic device through short-distance wireless communication. A short-distance wireless communication system for directly connecting to other electronic device includes, for example, Bluetooth (registered trademark) and WiFi (registered trademark). In the example illustrated in FIG. 1, the mobile phone 20 and the mobile phone 30 are directly communicating without via the public line network 90. In the situation illustrated in FIG. 1, the communication modules 6b of the mobile phones 20 and 30 are in a mutually communicable state.

The mobile phones 20 and 30 are owned by the same user. The mobile phone 20 is set so as to transmit, when an incoming call is received, originator (or caller, hereinafter, caller) information of received communication to the mobile phone 30 through short-distance wireless communication performed by the communication module 6b. The caller information is information related to a caller of the communication. The caller information includes, for example, a phone number of a caller.

For example, it is assumed that the mobile phone 40 makes an outgoing call to the mobile phone 20 at Step S11. The outgoing call reaches the mobile phone 20 via the base station 91a, the public line network 90, and the base station 91b. When detecting the incoming call, then at Step S12, the mobile phone 20 transmits the received caller information of the communication to the mobile phone 30 through short-distance wireless communication performed by the communication module 6b.

When receiving the received caller information of the communication, the mobile phone 30 determines whether information corresponding to the caller information is registered in a phone book. The information registered in the phone book includes, for example, a phone number, a name, a group, a company name, a profile, and an image. For example, the mobile phone 30 is configured to use a phone number of the caller information as key to retrieve information including the phone number that matches the key, and to determine, when the retrieval is successful, that the information corresponding to the caller information is registered in the phone book.

When the information corresponding to the caller information is registered in the phone book, then at Step S13, the mobile phone 30 informs the user of the incoming call using the information in the phone book corresponding to the caller information. For example, the mobile phone 30 is assumed to receive caller information including a phone number “090-1234-5678”. Moreover, in the phone book of the mobile phone 30, a name “Taro Sato” is assumed to be set to an item of Name in the information corresponding to the phone number “090-1234-5678”. In this case, the mobile phone 30 displays “Mr. Taro Sato” and “090-1234-5678” included in the information corresponding to the caller information as illustrated in FIG. 2, and informs the user of the incoming call.

In this way, when receiving the caller information related to the phone call received by the mobile phone 20, the mobile phone 30 retrieves the information corresponding to the caller information from the phone book, and performs control based on the retrieved information. By performing the control in this way, even when the incoming call is directly received from the public line network 90, or even when the incoming call received by the mobile phone 20 is notified, the mobile phone 30 can perform the same control based on the information registered in the phone book. As a result, it is possible to perform the same response to incoming calls from the same caller even when an incoming call received through any route is informed, thus improving the user's convenience with respect to the control of the information related to the incoming call.

For example, in the phone book of the mobile phone 20, there is a case in which only a family name “Sato” is registered in the item of Name in association with the phone number “090-1234-5678”. In this case, the mobile phone 20 can set “Sato” as a name to the caller information to be transmitted to the mobile phone 30. If the mobile phone 30 is configured so as to display the information included in the caller information at the time of notification of the call received via the mobile phone 20, the mobile phone 30 having received the caller information displays “Sato” instead of “Taro Sato” at the time of notification. This causes the names to be displayed in different ways at the time of notification depending on routes of incoming calls despite the reception of the incoming calls from the same caller using the same mobile phone, and the user may get confused thereby. In the present embodiment, the mobile phone 30 retrieves the information corresponding to the caller information from the phone book of its own device, and performs the control based on the retrieved information, thus reducing the possibility of occurrence of such confusion.

When the user having noticed the notification performs a predetermined off-hook operation on the mobile phone 30, a call between the mobile phone 20 and the mobile phone 40 is started. The off-hook operation is an operation for starting a call in response to an incoming call. The mobile phone 20 relays voice data from the mobile phone 30 or from the mobile phone 40 to the other during the call. When an on-hook operation is performed on the mobile phone 30 during the call, the mobile phone 20 disconnects the connection for the call with the mobile phone 40. The on-hook operation is an operation for ending the call in response to the incoming call.

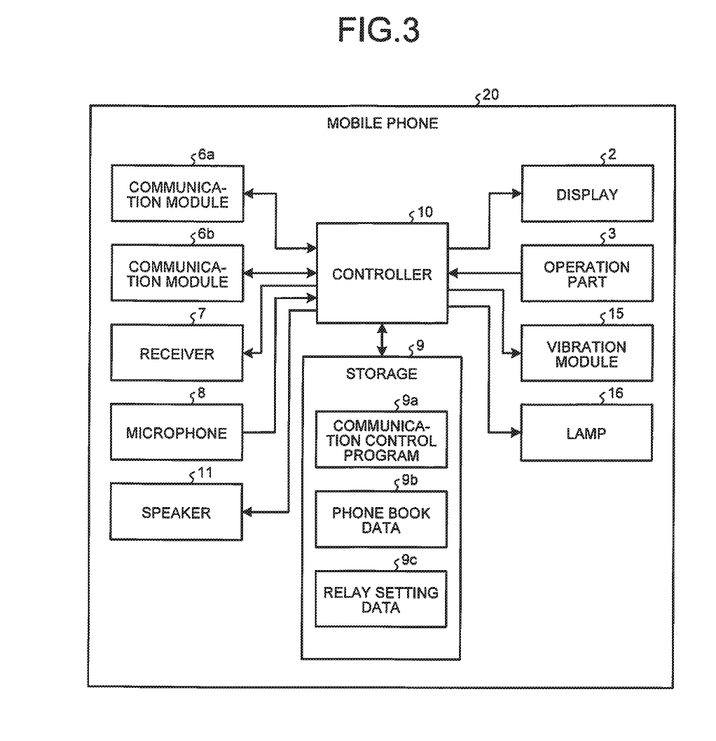

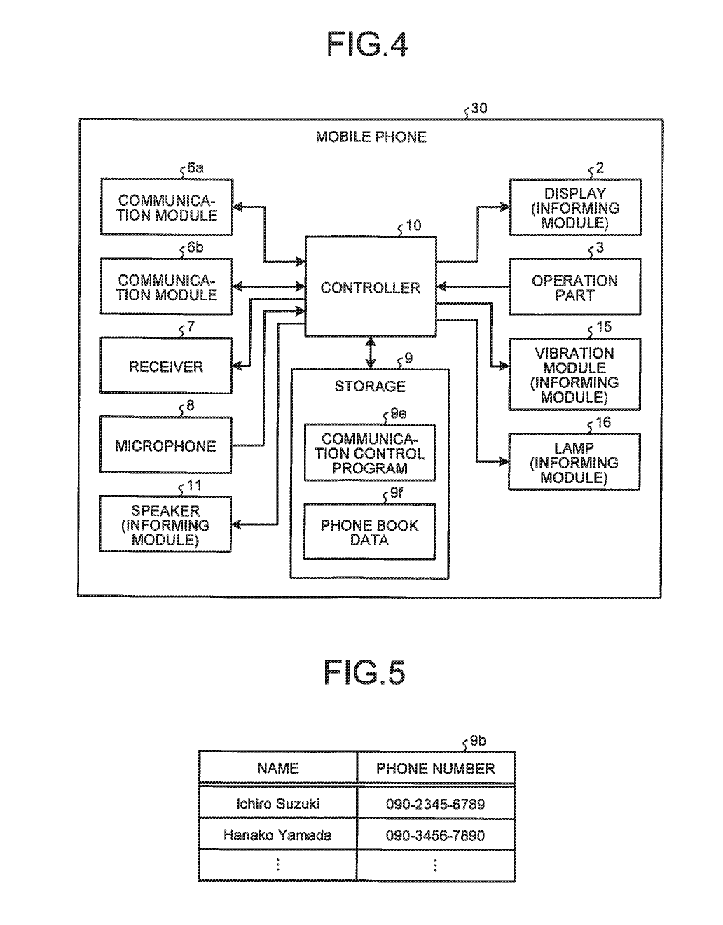

The configurations of the mobile phone 20 and the mobile phone 30 illustrated in FIG. 1 and FIG. 2 will be explained next with reference to FIG. 3 and FIG. 4. In the explanation herein below, the same reference signs may be assigned to those similar to the components. Moreover, overlapping explanation may be omitted.

FIG. 3 is a block diagram of the mobile phone 20, i.e., of the mobile phone 20 for relaying voice data of a communication. As illustrated in FIG. 3, the mobile phone 20 includes a display 2, an operation part 3, a communication module 6a, a communication module 6b, a receiver 7, a microphone 8, a storage 9, a controller 10, a speaker 11, a vibration module 15, and a lamp 16.

The display 2 includes a display panel such as a liquid crystal display and an organic electro-luminescence display. The display 2 displays information such as text, graphics, and images according to a signal input from the controller 10. The information displayed in the display 2 includes a screen image for notification, icons, and so on.

The operation part 3 includes one or more devices for a user's operation. The device for a user's operation includes, for example, a key, a button, and a touch screen. The operation part 3 inputs a signal according to the user's operation to the controller 10.

The communication module 6a is a communication module for performing communication using a first communication system. In the present embodiment, the first communication system is a communication system such as 2G, 3G, and 4G for performing communication via the public line network 90. A communication standard for performing communication via the public line network 90 includes, for example, LTE (Long Term Evolution), W-CDMA (Wideband Code Division Multiple Access), CDMA 2000, PDC (Personal Digital Cellular), GSM (registered trademark) (Global System for Mobile Communications), and PHS (Personal Handy-phone System). The first communication system may be a communication system for performing data communication via the public line network 90 like WiMAX (Worldwide Interoperability for Microwave Access). When the first communication system is a communication system for performing data communication, a phone call is implemented by combining a technology for data transmission with a technology, such as VoIP (Voice over Internet Protocol), for transmitting voice as data. The communication module 6a may support a plurality of communication systems for performing communication via the public line network 90.

The communication module 6b is a communication module for performing communication using a second communication system. In the present embodiment, the second communication system is a short-distance wireless communication system. The short-distance wireless communication system includes Bluetooth (registered trademark), wireless LAN (IEEE 802.11), ZigBee, infrared communication, visible light communication, NFC (Near Field Communication), and the like. The communication module 6b may support a plurality of short-distance wireless communication systems.

The receiver 7 and the speaker 11 are sound output modules. The receiver 7 and the speaker 11 output a sound signal input from the controller 10 as sound. The receiver 7 is used, for example, to output the voice of a call partner during a call. The speaker 11 is used, for example, to output a ringtone and music. One of the receiver 7 and the speaker 11 may also serve as the function of the other. The microphone 8 is a sound input module. The microphone 8 converts a user's voice or the like into a sound signal and inputs the sound signal to the controller 10.

The storage 9 stores programs and data. The storage 9 is used also as a work area that temporarily stores a processing result of the controller 10. The storage 9 may include any non-transitory storage medium such as a semiconductor storage medium and a magnetic storage medium. The storage 9 may include a plurality of types of storage mediums. The storage 9 may include a combination of a portable storage medium such as a memory card, an optical disk, or a magneto-optical disk with a reading device of the storage medium. The storage 9 may include a storage device used as a temporary storage area such as RAM (Random Access Memory).

The storage 9 stores, for example, a communication control program 9a, phone book data 9b, and relay setting data 9c. The communication control program 9a provides a function of relaying voice data of a communication received by the communication module 6a to the other electronic device via the communication module 6b and also provides a function of transmitting the caller information to the other electronic device upon relaying. The phone book data 9b includes various pieces of information for a call partner. The relay setting data 9c includes information on various settings related to relaying of the voice data of the communication.

Items of the phone book data 9b and the relay setting data 9c may be appropriately distributed or may be aggregated.

The controller 10 is a processor. Examples of the processor include, but are not limited to, a CPU (Central Processing Unit), SoC (System-on-a-chip), an MCU (Micro Control Unit), an FPGA (Field-Programmable Gate Array), and a coprocessor. The controller 10 integrally controls the operations of the mobile phone 20 to implement the various functions.

Specifically, the controller 10 executes commands contained in the program stored in the storage 9 while referring to the data stored in the storage 9 as necessary. The controller 10 then controls a function module according to the data and the commands and thereby implements the various functions. Examples of the function module include, but are not limited to, the display 2, the communication modules 6a and 6b, the receiver 7, the speaker 11, the vibration module 15, and the lamp 16. The controller 10 can change the control according to the detection result of a detector. Examples of the detector include, but are not limited to, the operation part 3, the communication modules 6a and 6b, and the microphone 8.

The controller 10 executes the communication control program 9a, and thereby performs the operations of the mobile phone 20 in the communication control method illustrated in FIG. 1 and FIG. 2.

The vibration module 15 vibrates the mobile phone 20. The vibration module 15 uses, for example, a piezoelectric element or an eccentric motor in order to vibrate the mobile phone 20. The lamp 16 emits light in set color and pattern. The lamp 16 has a light source such as LED (Light Emitting Diode), and is mounted on the mobile phone 20 so that the light emitted from the light source can be visually recognized from the outside. The display 2, the speaker 11, the vibration module 15, and the lamp 16 are used to inform the user of an incoming phone call, mail reception, and arrival of the time registered in a schedule, and the like.

FIG. 4 is a block diagram of the mobile phone 30, i.e., of the mobile phone 30 to which voice data of the communication is relayed. As illustrated in FIG. 4, the mobile phone 30 includes the display 2, the operation part 3, the communication module 6a, the communication module 6b, the receiver 7, the microphone 8, the storage 9, the controller 10, the speaker 11, the vibration module 15, and the lamp 16.

The storage 9 stores, for example, a communication control program 9e and phone book data 9f. The communication control program 9e provides a function of performing control according to the information registered in the phone book data 9f when a communication arrives. The phone book data 9f includes various pieces of information for the call partner. The phone book data 9f has the same configuration as that of the phone book data 9b of the mobile phone 20.

The controller 10 executes the communication control program 9e, and thereby performs the operations of the mobile phone 30 in the communication control method illustrated in FIG. 1 and FIG. 2.

The display 2, the speaker 11, the vibration module 15, and the lamp 16 function as an informing module for informing the user of an incoming phone call, mail reception, and arrival of the time registered in a schedule, and the like.

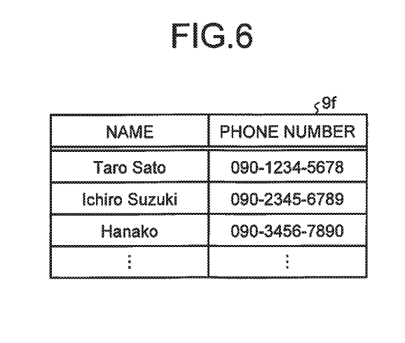

The phone book data 9b and the phone book data 9f will be explained below with reference to FIG. 5 and FIG. 6. FIG. 5 and FIG. 6 are diagrams illustrating examples of phone book data. As illustrated in FIG. 5 and FIG. 6, the phone book data 9b and the phone book data 9f include items such as Name and Phone Number. A name of a call partner is set to the item of Name. A phone number of a call partner is set to the item of Phone Number.

In the example illustrated in FIG. 5, the phone book data 9b includes pieces of information corresponding to “Ichiro Suzuki” and “Hanako Yamada”. In the information on a first line, “Ichiro Suzuki” is set to the item of Name, and “090-2345-6789” is set to the item of Phone Number. In the information on a second line, “Hanako Yamada” is set to the item of Name, and “090-3456-7890” is set to the item of Phone Number.

In the example illustrated in FIG. 6, the phone book data 9f includes pieces of information corresponding to “Taro Sato”, “Ichiro Suzuki”, and “Hanako”. In the information on a first line, “Taro Sato” is set to the item of Name, and “090-1234-5678” is set to the item of Phone Number. In the information on a second line, “Ichiro Suzuki” is set to the item of Name, and “090-2345-6789” is set to the item of Phone Number. In the information on a third line, “Hanako” is set to the item of Name, and “090-3456-7890” is set to the item of Phone Number.

In the examples illustrated in FIG. 5 and FIG. 6, the information for “Taro Sato” is registered in the phone book data 9f but not registered in the phone book data 9b. In the examples illustrated in FIG. 5 and FIG. 6, the item of Name in the phone book data 9b for the information for “090-3456-7890” is registered to correspond to “Hanako Yamada” and the item of Name in the phone book data 9f for the information for “090-3456-7890” is registered to correspond to “Hanako”. In other words, in the information for “090-3456-7890”, the values in the item of Name between the phone book data 9b and the phone book data 9f do not match each other.

The information to be registered in the phone book is not limited to the examples of FIG. 5 and FIG. 6. For example, the phone book may include other items such as a mail address, an address, and position information.

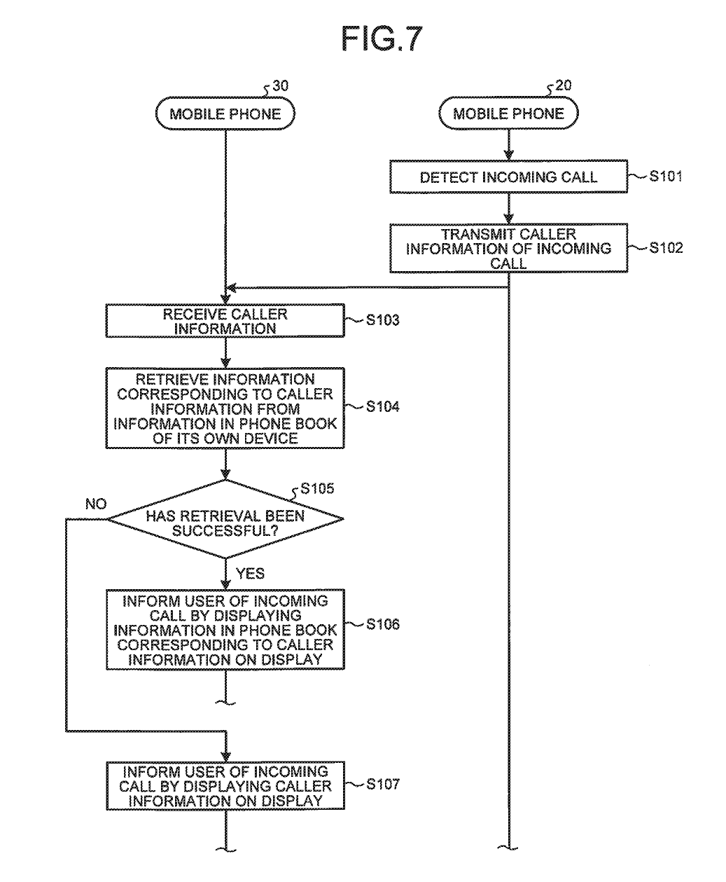

Operations of the mobile phone 20 and the mobile phone 30 upon the arrival of a communication will be explained below with reference to FIG. 7. FIG. 7 is a sequence diagram illustrating the operations upon the arrival of a communication. The operations illustrated in FIG. 7 are executed when the relay setting data 9c of the mobile phone 20 is set so that the mobile phone 20 relays voice data of the communication received by the mobile phone 20 between the caller of the communication and the mobile phone 30. The operation of the mobile phone 20 illustrated in FIG. 7 is implemented by the controller 10 of the mobile phone 20 executing the communication control program 9a. The operation of the mobile phone 30 illustrated in FIG. 7 is implemented by the controller 10 of the mobile phone 30 executing the communication control program 9e.

As illustrated in FIG. 7, when detecting an incoming call at Step S101, then at Step S102, the controller 10 of the mobile phone 20 transmits caller information of the incoming call to the mobile phone 30 via the communication module 6b.

When receiving the caller information via the communication module 6b at Step S103, then at Step S104, the controller 10 of the mobile phone 30 retrieves information corresponding to the caller information from the phone book data 9f of its own device. The controller 10 of the mobile phone 30 uses identification information of the caller included in the caller information as key and retrieves the information in which keys match each other from the phone book data 9f. The identification information of the caller is, for example, a phone number, a mail address, an IP address, a domain name, and a MAC address.

The controller 10 of the mobile phone 30 determines whether the retrieval at Step S104 has been successful at Step S105. When the retrieval has been successful (“Yes” at Step S105), the controller 10 of the mobile phone 30 proceeds to Step S106. At Step S106, the controller 10 of the mobile phone 30 informs the user of the incoming call by displaying the information in the phone book data 9f corresponding to the caller information on the display 2. Thereafter, the controller 10 of the mobile phone 30 performs a normal operation for an incoming call.

When the retrieval has not been successful (No at Step S105), then at Step S107, the controller 10 of the mobile phone 30 informs the user of the incoming call by displaying the caller information received from the mobile phone 20 on the display 2. For example, at Step S102, the controller 10 of the mobile phone 20 retrieves information corresponding to the caller of the incoming call from the phone book data 9b, and sets the retrieved information such as a name to the caller information. At Step S107, the caller information set by the controller 10 of the mobile phone 20 in this manner is displayed. Thereafter, the controller 10 of the mobile phone 30 performs the normal operation for an incoming call.

As explained above, in the present embodiment, at the time of starting relay of the voice data of a communication, the mobile phone 30 in the side of receiving the relay of the voice data of the communication retrieves the information, from the phone book, corresponding to the caller information transmitted from the mobile phone 20 at which the communication arrives, and performs the control based on the result. Therefore, it is possible to perform consistent control based on the phone book regardless of whether the communication is to be relayed, thus improving the user's convenience with respect to the control of the information related to the incoming call.

The embodiment disclosed in the present application can be modified within a range that does not depart from the gist and the scope of the invention. Moreover, the embodiment and modifications thereof disclosed in the present application can be combined with each other if necessary. For example, the embodiment may be modified as follows.

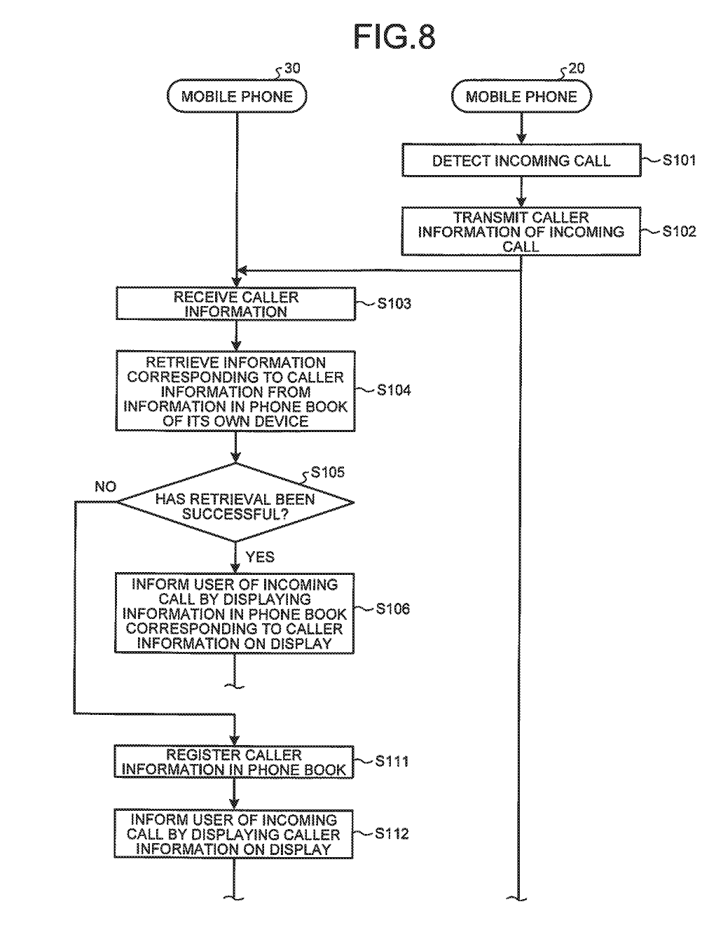

A modification of the operations of the mobile phone 20 and the mobile phone 30 upon the arrival of a communication will be explained below with reference to FIG. 8. FIG. 8 is a sequence diagram illustrating a modification of the operations upon the arrival of the communication. Step S101 to Step S106 among the operations illustrated in FIG. 8 are the same as Step S101 to Step S106 illustrated in FIG. 7.

When the retrieval of the information corresponding to the caller information from the information in the phone book data 9f has not been successful (No at Step S105), the controller 10 of the mobile phone 30 proceeds to Step S111. At Step S111, the controller 10 of the mobile phone 30 registers the caller information received from the mobile phone 20 in the phone book data 9f. For example, at Step S102, the controller 10 of the mobile phone 20 retrieves the information corresponding to the caller of the incoming call from the phone book data 9b, and sets the retrieved information such as a name to the caller information. At Step S111, the caller information set by the controller 10 of the mobile phone 20 in this manner is registered in the phone book data 9f. Then, at Step S112, the controller 10 of the mobile phone 30 informs the user of the incoming call by displaying the caller information on the display 2. Thereafter, the controller 10 of the mobile phone 30 performs the normal operation for an incoming call.

In this modification, when the information corresponding to the caller information is not registered in the phone book data 9f, the mobile phone 30 registers the received caller information in the phone book data 9f. Thus, the mobile phone 30 can register the information on the caller in the phone book data 9f without bothering the user. The mobile phone 30 asks for confirmation, from the user, whether the caller information may be registered in the phone book data 9f during communication or after completion of the communication, and may register the caller information in the phone book data 9f only when the registration is admitted.

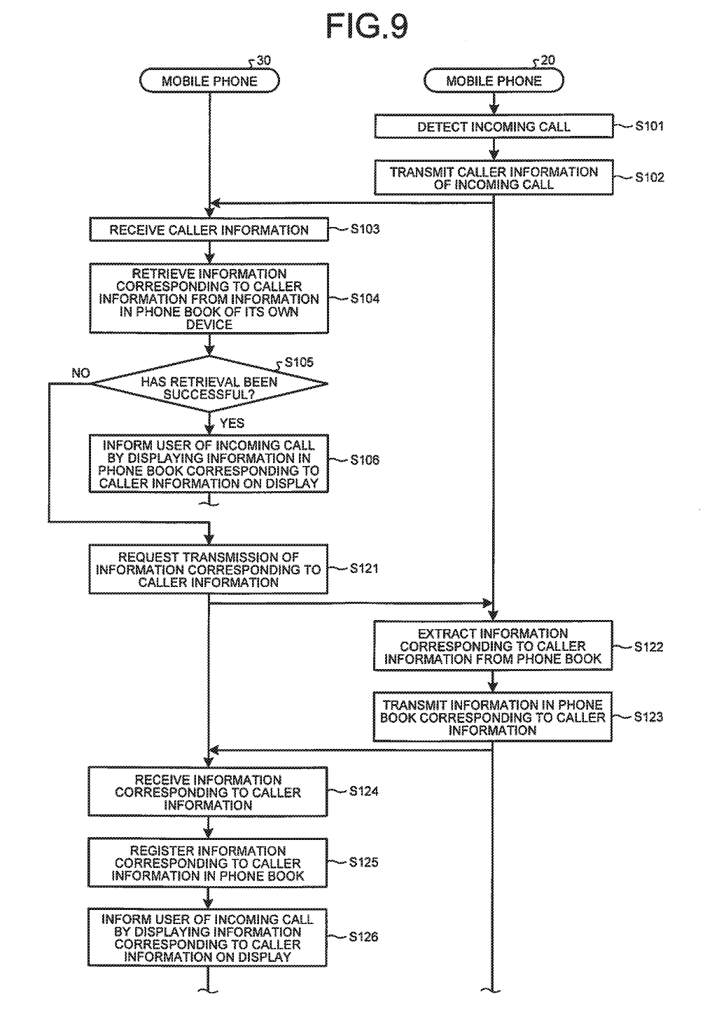

Another modification of the operations of the mobile phone 20 and the mobile phone 30 upon the arrival of a communication will be explained below with reference to FIG. 9. FIG. 9 is a sequence diagram illustrating another modification of the operations upon the arrival of the communication. Step S101 to Step S106 among the operations illustrated in FIG. 9 are the same as Step S101 to Step S106 illustrated in FIG. 7.

When the retrieval of the information corresponding to the caller information from the information in the phone book data 9f has not been successful (No at Step S105), the controller 10 of the mobile phone 30 proceeds to Step S121. At Step S121, the controller 10 of the mobile phone 30 requests the transmission of the information corresponding to the caller information. In the example illustrated in FIG. 9, the controller 10 of the mobile phone 30 requests the transmission of the information corresponding to the caller information from the mobile phone 20 via the communication module 6b. For example, when the phone book of the mobile phone 20 is registered in a database on a network, the controller 10 of the mobile phone 30 may request the transmission of the information corresponding to the caller information from a server that manages the database. The mobile phone 30 may request the transmission of the caller information from other electronic device via the public line network 90.

When receiving the transmission request of the information corresponding to the caller information, then at Step S122, the controller 10 of the mobile phone 20 extracts the information corresponding to the caller information from the phone book data 9b. Specifically, the controller 10 of the mobile phone 20 extracts the information corresponding to the caller of the communication the arrival of which is detected at Step S101 from the phone book data 9b. At Step S123, the controller 10 of the mobile phone 20 transmits the information in the phone book data 9b corresponding to the caller information to the mobile phone 30.

When receiving the information corresponding to the caller information at Step S124, then at Step S125, the controller 10 of the mobile phone 30 registers the information corresponding to the caller information in the phone book data 9f. At Step S126, the controller 10 of the mobile phone 30 informs the user of the incoming call by displaying the information corresponding to the caller information on the display 2.

In this modification, when the information corresponding to the caller information is not registered in the phone book data 9f, the mobile phone 30 requests the information corresponding to the caller information from the mobile phone 20, and registers the received information in the phone book data 9f. This enables the mobile phone 30 to register the information for the caller in the phone book data 9f without bothering the user. Furthermore, the caller information is not registered in the phone book data 9f, thus reducing the information to be included in the caller information. The mobile phone 30 asks the user for confirmation whether a request of the transmission of the information may be transmitted to the mobile phone 20, and may transmit the request to the mobile phone 20 only when the request is admitted.

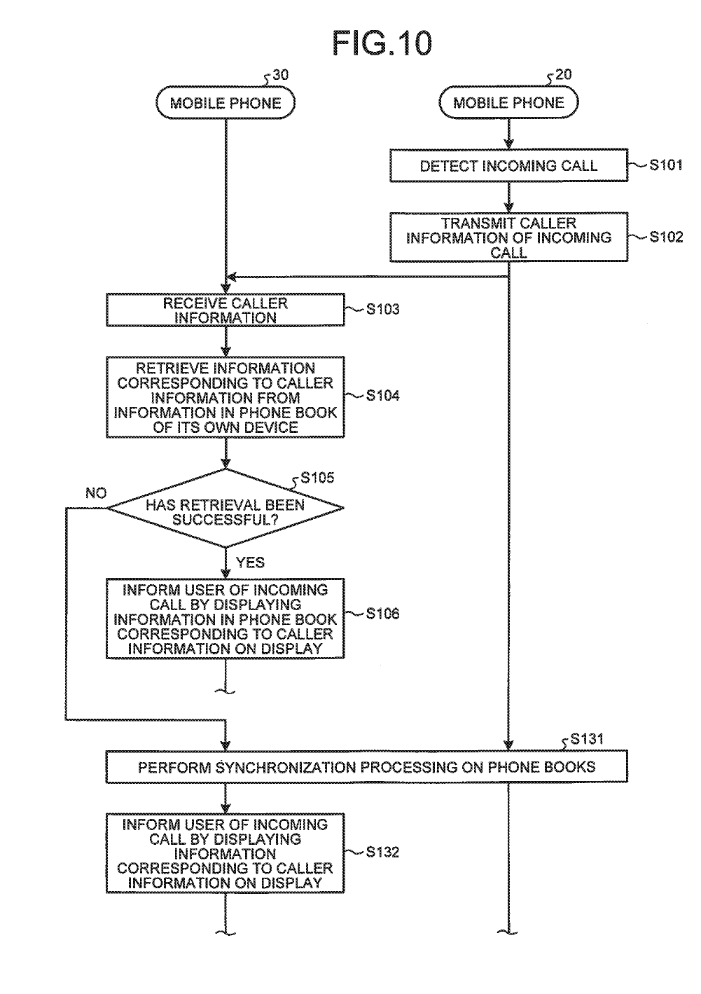

Further another modification of the operations of the mobile phone 20 and the mobile phone 30 upon the arrival of a communication will be explained below with reference to FIG. 10. FIG. 10 is a sequence diagram illustrating further another modification of the operations upon the arrival of the communication. Step S101 to Step S106 among the operations illustrated in FIG. 10 are the same as Step S101 to Step S106 illustrated in FIG. 7.

When the retrieval of the information corresponding to the caller information from the information in the phone book data 9f has not been successful (No at Step S105), the controller 10 of the mobile phone 30 proceeds to Step S131. At Step S131, the controllers 10 of the mobile phone 20 and of the mobile phone 30 perform synchronization processing on the phone books.

Specifically, the controller 10 of the mobile phone 30 requests synchronization of the phone book from the mobile phone 20 and transmits the phone book data 9f to the mobile phone 20. The controller 10 of the mobile phone 20 transmits the phone book data 9b to the mobile phone 30 in response to the request of the synchronization. The controller 10 of the mobile phone 30 detects a difference between the phone book data 9b and the phone book data 9f, and registers information for the detected difference in the phone book data 9f. The controller 10 of the mobile phone 20 detects a difference between the phone book data 9b and the phone book data 9f, and registers information for the detected difference in the phone book data 9b. The method of synchronizing the phone books is not particularly limited. If there are overlapping pieces of information, it may be configured to store the last updated information or to store information of one of the mobile phone 20 and the mobile phone 30 to which a higher priority is previously given.

In this modification, when detecting a mismatch between the phone book data 9f and the phone book data 9b, the phone book data 9f and the phone book data 9b are synchronized. This makes it possible to match the contents between the phone book data 9f and the phone book data 9b. Thereafter, at Step S132, the controller 10 of the mobile phone 30 informs the user of the incoming call by displaying the information in the phone book data 9f corresponding to the caller information on the display 2. Then the controller 10 of the mobile phone 30 performs the normal operation for an incoming call.

In the example illustrated in FIG. 10, it may be configured that, at Step S102, the controller 10 of the mobile phone 20 retrieves information corresponding to the caller of the incoming call from the phone book data 9b and sets the retrieved information such as a name to the caller information, and that when the retrieval of the information corresponding to the caller information has been successful at Step S105, the controller 10 of the mobile phone 30 compares the retrieved information and the information set in the caller information. The comparison is performed between the same items such as names and addresses. In this case, when detecting items that do not match each other, the controller 10 of the mobile phone 20 performs the synchronization processing on the items at Step S131. Thus, by detecting a mismatch in an item unit, the phone book data 9f and the phone book data 9b can be more precisely synchronized.

The embodiment and the modifications thereof may further be modified as follows. For example, the programs illustrated in FIG. 3 and FIG. 4 may be divided into a plurality of modules, or may be combined with the other program.

The embodiment has explained the case in which when the caller information is to be transmitted to the mobile phone 30, the mobile phone 20 transmits the caller information through short-distance wireless communication. However, it may be configured that it is transmitted via a public line network different from that of the communication module 6a. Specifically, the communication standard supported by the communication module 6b is changed from a short-distance wireless communication standard to a cellular-phone communication standard. In other words, a combination of the communication standards supported by the communication module 6a and the communication module 6b may be any combination of, for example, 2G and 3G, 3G and 4G, and 3G and PHS.

The embodiment has explained the example of informing the user of an incoming call as an example of the control performed by the mobile phone 30 by referring to the phone book when the incoming call of communication is notified; however, the control performed by referring to the phone book is not limited thereto. For example, when information on call rejection is included in the phone book, whether to reject an incoming call may be determined based on the result of referring to the phone book.

The embodiment has explained the case in which the mobile phone 20 has a function of relaying the data of a communication and the mobile phone 30 has a function of receiving the relay of the data of the communication; however, each of the mobile phone 20 and the mobile phone 30 may include both the function of relaying data of a communication and the function of receiving the relay.

The embodiment has explained the case in which the mobile phones 20 and 30 are owned by the same user; however, the case is not limited thereto. The mobile phones 20 and 30 may be owned by different users. For example, the mobile phone 20 may be owned by a parent and the mobile phone 30 may be owned by his/her child.

The embodiment has explained the case in which the mobile phone 20 notifies the mobile phone 30 of an incoming phone call; however, the case is not limited thereto. For example, when the mobile phone 20 receives a message via SMS (Short Message Service), this case can also be applied to a case in which the reception is notified to the mobile phone 30. In this case, when a phone number of the sender (originator) is registered in the phone book, it has only to be configured so that the mobile phone 30 notifies the user of the incoming message based on the information in the phone book. Moreover, when the mobile phone 20 receives an email, this case can also be applied to a case in which the reception is notified to the mobile phone 30. In this case, when a mail address of the sender is registered in the phone book, it has only to be configured so that the mobile phone 30 notifies the user of the incoming email based on the information in the phone book.

Although the art of appended claims has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

### REFERENCE SIGNS LIST

2 DISPLAY

3 OPERATION PART

6a, 6b COMMUNICATION MODULE

7 RECEIVER

8 MICROPHONE

9 STORAGE

9a, 9e COMMUNICATION CONTROL PROGRAM

9b, 9f PHONE BOOK DATA

9c RELAY SETTING DATA

10 CONTROLLER

11 SPEAKER

15 VIBRATION MODULE

16 LAMP

20 MOBILE PHONE

30 MOBILE PHONE

40 MOBILE PHONE

90 PUBLIC LINE NETWORK

91a, 91b BASE STATION

1. An electronic device comprising:
a communication module for communicating with other electronic device; and
a controller for performing, when originator information related to an originator of a communication received by the other electronic device is notified, control for the originator information by referring to information in a phone book.

2. The electronic device according to claim 1, wherein, when an incoming call along with the originator information including a phone number of an incoming voice call received by the other electronic device is notified,
the controller performs the control for the phone number by referring to the information in the phone book.

3. The electronic device according to claim 1, further comprising a display, wherein
the controller displays a piece of information corresponding to the notified originator information, among pieces of the information in the phone book, on the display.

4. The electronic device according to claim 1, wherein, when the information corresponding to the notified originator information is not registered in the phone book,
the controller registers the originator information in the phone book.

5. The electronic device according to claim 1, wherein, when the information corresponding to the notified originator information is not registered in the phone book,
the controller acquires information for the originator from the other electronic device and registers the acquired information in the phone book.

6. The electronic device according to claim 1, wherein, when the information corresponding to the notified originator information is not registered in the phone book,
the controller updates the phone book by performing synchronization processing with a phone book of the other electronic device.

7. A control method for an electronic device including a communication module, the control method comprising:
a step of communicating with other electronic device in the communication module; and
a step of performing, when originator information related to an originator of a communication received by the other electronic device is notified, control for the originator information by referring to information in a phone book.
